(19) United States
(12) Patent Application Publication
(10) Pub. No.: US 2007/0140463 A1
(43) Pub. Date: Jun. 21, 2007

(54) Telephone exchange apparatus and method for controlling incoming call thereof

(75) Inventor: Tadafumi Murata, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/636,983

(22) Filed: Dec. 12, 2006

(30) Foreign Application Priority Data
Dec. 16, 2005 (JP) 2005-363406

(51) Int. Cl. H04M 7/00

(52) U.S. Cl. 379/219

(57) ABSTRACT

According to one embodiment, a telephone exchange apparatus includes a memory which stores a management table in which a terminal ID specifying a first telephone terminal and a terminal ID specifying a second telephone terminal are related with each other, when an operation key to receive an incoming call from the second telephone terminal by the first telephone terminal on the highest priority in a state in which a call connection has established between the first telephone terminal and the second telephone terminal among the plurality of telephone terminals, and a controller which refers to the management table based on a terminal ID of an outgoing call origin included in the incoming call when an incoming call destined to the first telephone terminal reaches, and executes incoming call control to the first telephone terminal only when the reference result shows that an outgoing call origin is the second telephone terminal.

### CROSS-REFERENCE TO RELATED APPLICATIONS

This application is based upon and claims the benefit of priority from Japanese Patent Application No. 2005-363406, filed Dec. 16, 2005, the entire contents of which are incorporated herein by reference.

### BACKGROUND

1. Field

One embodiment of the invention relates to a telephone exchange apparatus and a method for controlling incoming calls thereof equipped with a variety of functions regarding exchange processing among a plurality of telephone terminals.

2. Description of the Related Art

A telephone exchange apparatus such as a key telephone apparatus has a variety of functions regarding exchange processing among a plurality of telephone terminals and one of them is a function of receiving only a specific incoming call. The function is one that preliminarily registers telephone numbers of important customers, etc., to be received at a specific telephone terminal in the telephone exchange apparatus and makes the specific telephone terminal receive the incoming call based on the foregoing registered telephone numbers (for example, Jpn. Pat. Appln. KOKAI Publication No. 6-225020).

By the way, in the telephone exchange apparatus, it is presumed that a user of an A company interrupts a telephone call once and dials again to the same extension terminal in a state of making the telephone call between the user of the A company on a network side and a user of an extension terminal belonging to a B company. However, the user of the extension terminal possibly starts other telephone call with a user of other extension terminal, and the user of the A company cannot transmit a message sometimes. Therefore, the user of the A company has to transmit the message again to a user of another extension terminal belonging to the B company, so that the user of the A company feels inconvenience.

Although it is conceivable to set the user of the extension terminal in the B company so as not to receive any incoming call form other than the user of the A company, for that purpose the telephone exchange apparatus has to register the user of the A company, therefore, a method, which can set to receive the incoming call from the user of the A company during telephone call or after the telephone call, is strongly desired for a long time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an exchange system regarding a first embodiment of the present invention;

FIG. 2 is an exemplary view showing one example of a storage content of a final calling party management table shown in FIG. 1;

FIG. 3 is an exemplary flowchart showing a control processing procedure of a central control unit when bringing an extension terminal into a state of giving an incoming call from a final calling party priority in the first embodiment of the present invention;

FIG. 4 is an exemplary flowchart showing a control processing procedure of a central control unit when an incoming call arrives at the extension terminal in the first embodiment of the present invention;

FIG. 5 is an exemplary flowchart showing a control processing procedure of a central control unit when releasing the state of giving the incoming call from the final calling party priority of the extension terminal by depressing a final calling party incoming call priority key as a second embodiment of the present invention; and

FIG. 6 is an exemplary flowchart showing a control processing procedure of a central control unit at the time of time-out by a timer as a third embodiment of the present invention.

### DETAILED DESCRIPTION

Various embodiments according to the invention will be described hereinafter with reference to the accompanying drawings, in general, according to one embodiment of the invention, a telephone exchange apparatus executing exchange processing among a plurality of telephone terminals, comprising: a memory which stores a management table in which a terminal ID specifying a first telephone terminal and a terminal ID specifying a second telephone terminal are related with each other, when an operation key to receive an incoming call from the second telephone terminal by the first telephone terminal on the highest priority in a state in which a call connection has established between the first telephone terminal and the second telephone terminal among the plurality of telephone terminals; and a controller which refers to the management table based on a terminal ID of an outgoing call origin included in the incoming call when an incoming call destined to the first telephone terminal reaches, and executes incoming call control to the first telephone terminal only when the reference result shows that an outgoing call origin is the second telephone terminal.

### FIRST EMBODIMENT

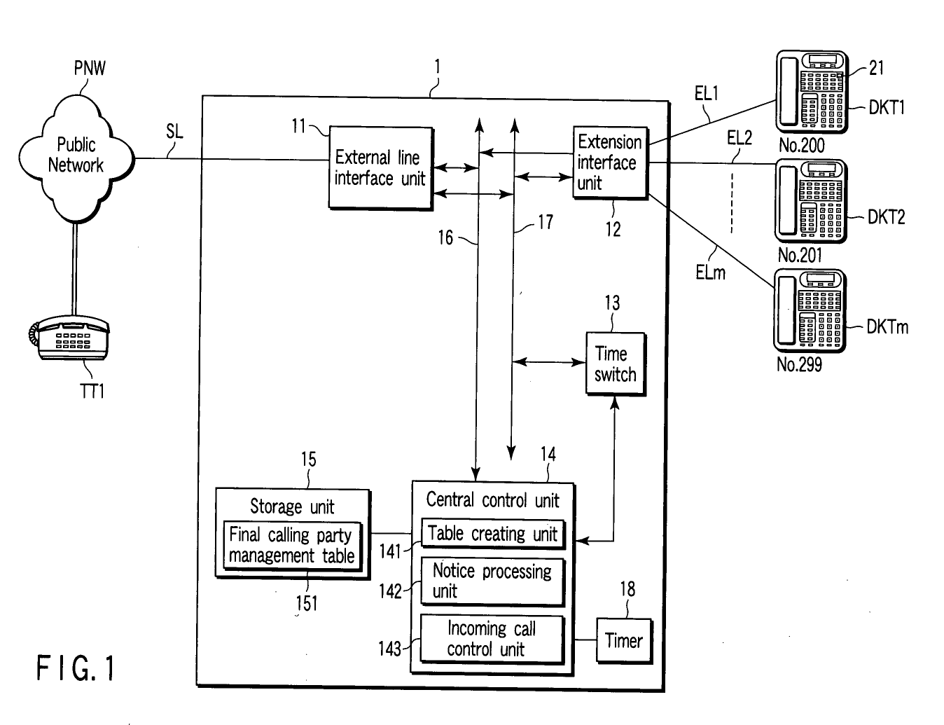

FIG. 1 is a block diagram depicting a configuration of an exchange system regarding a first embodiment of the present invention, and the block diagram includes a main apparatus 1.

The main apparatus 1 has an external line interface unit 11, and extension interface unit 12, a time switch 13, a central control unit 14, and a storage unit 15. Out of them, the external line interface unit 11, extension interface unit 12 and central control unit 14 are connected with one another via a control bus 16. The external line interface unit 11, extension interface unit 12 and time switch 13 are connected with one another via a voice bus 17.

The external line interface unit 11 is connected to a public network PNW via a subscriber line SL to perform establishment processing, etc., of a call to and from the public network PNW.

A plurality of extensions EL1-ELm (m is natural number) are housed in the extension interface unit 12, and each extension terminal DKT1-DKTm are connected to the extensions EL1-ELm, respectively. Digital key telephone sets, for example, are used as the extension terminals DKT1-DKTm. The extension interface unit 12 performs outgoing/incoming call processing and transfer processing, etc., of digital signals to the extension terminals DKT1-DKTm.

The time switch 13 conducts channel exchange of the digital signals transmitted between the external line interface unit 11 and the extension interface unit 12 via the voice bus 17 in accordance with the instructions from the central control unit 14.

The central control unit 14 executes outgoing call processing accompanied by call requests from each extension terminal DKT1-DKTm, ordinary incoming call processing accompanied by external line incoming calls from the subscriber line SL, and transfer processing among the extension terminals DKT1-DKTm.

Control data needed for the control processing by the central control unit 14 is stored in the storage unit 15.

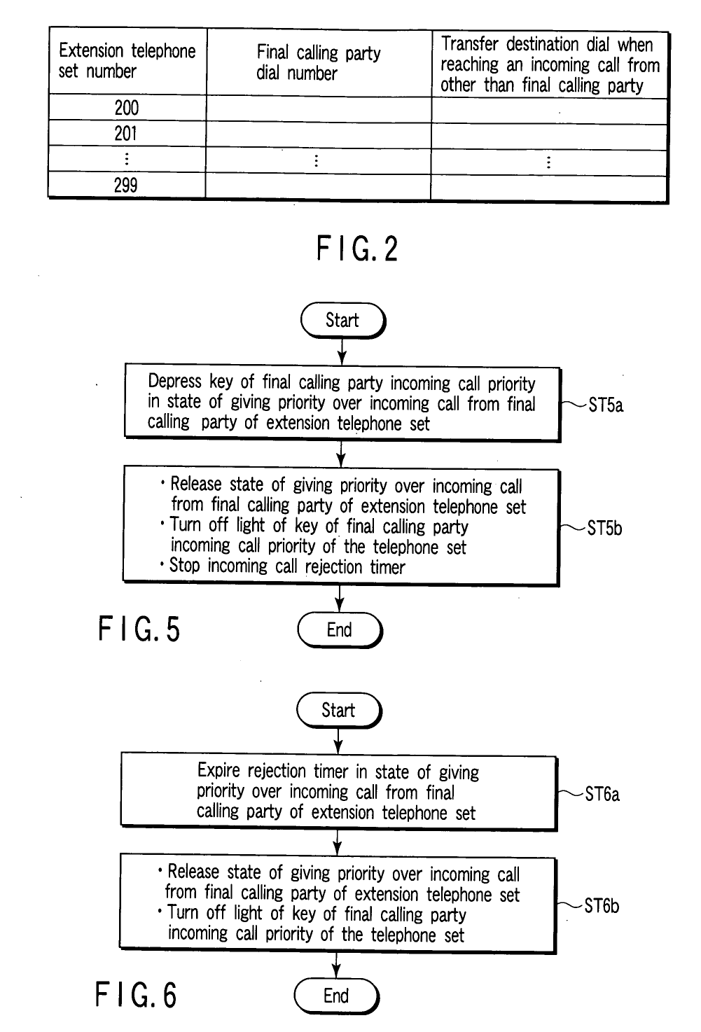

Meanwhile, in the first embodiment, the central control unit 14 includes a table creating unit 141, a notice processing unit 142 and an incoming call control unit 143. When a key 21 to receive an incoming call from the external telephone terminal TT1 is depressed on the highest priority at the extension terminal DKT1 in a state, for instance, in which a call connection is established between the external telephone terminal TT1 and the extension terminal DKT1, the table creating unit 141 creates data showing correspondences among a telephone number as a terminal ID specifying the external telephone terminal TT1, an extension telephone number (200) of the extension terminal DKT1 and an extension telephone number (299) of the extension terminal DKTm to be an incoming call transfer destination for the extension terminal DKT1 to store it in a final calling party management table 151 (hereinafter, referred to as table 151) in the storage unit 15. The table 151 results in storing such data shown in FIG. 2.

On the other hand, the central control unit 14 starts a timer 18 measuring an incoming call reject time to reject incoming calls other than those from the external telephone terminal TT1.

The notice processing unit 142 notifies the message, showing a state of giving a priority over a final calling party, to a user by lighting or blinking the light emitting diode (LED) of the key 21 when any data is created by the table creating unit 141.

When an incoming call destined to the extension terminal DKT1 reaches, the incoming call control unit 143 refers to the table 151 based on the telephone number of an outgoing call origin included in the incoming call to execute incoming call control for the extension terminal DKT1 only when the reference results shows that the outgoing call origin is the external telephone terminal TT1. Within the measurement time by the timer 18, if the outgoing call origin is other than the external telephone terminal TT1, the incoming call control unit 143 executes the incoming call transfer control to the extension terminal DKTm to be the incoming call transfer destination.

Next to this, operations of the system configured as given above will be described.

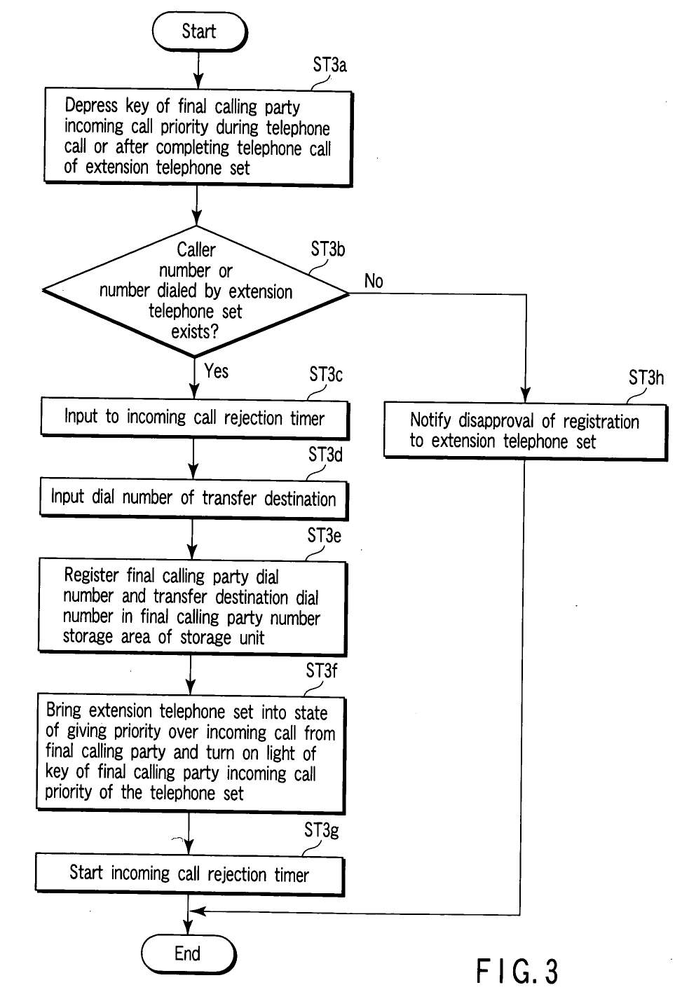

FIG. 3 is a flowchart depicting a control processing procedure of the central control unit 14 in bringing the extension terminal DKT1 into the sate of giving the priority over the incoming call from the final calling party.

For instance, it is supposed that a telephone call has been made between the extension terminal DKT1 and the external telephone terminal TT1. During the telephone call or after completing it, at the extension terminal DKT1, it is presumed that the user depresses the key 21 of the extension terminal DKT1. The central control unit 14 then shifts from a block ST3a to a block ST3b, and here it determines whether or not the telephone number of the external telephone terminal TT1 exists. Here, the telephone number existing, the central control unit 14 prompts the user of the extension terminal DKT1 to input the incoming call rejection time to be set to the timer 18 (block ST3c), and also prompts the user to input the dial number of the incoming call transfer destination (block ST3d).

In the state, it is assumed that the user inputs the incoming call rejection time and the dial number of the incoming call transfer destination through the extension terminal DKT1. The central control unit 14 then stores the telephone number of the external telephone terminal TT1 and the dial number of the transfer destination in the table 151 by relating them to the extension telephone number of the extension terminal DKT1 (block ST3e). The central control unit 14 further lights or blinks the LED of the key 21 so as to notify the message telling that the extension terminal DKT1 is in the state of giving the priority over the incoming call from the final calling party to the user (block ST3f) and starts the timer 18 (block ST3g).

In the block ST3b, if the telephone number of the external telephone terminal TT1 has not been notified, the central control unit 14 notifies that the telephone number of the external telephone terminal TT1 cannot be registered to the user of the extension terminal DKT1 by means of a display or a tone signal (block ST3h).

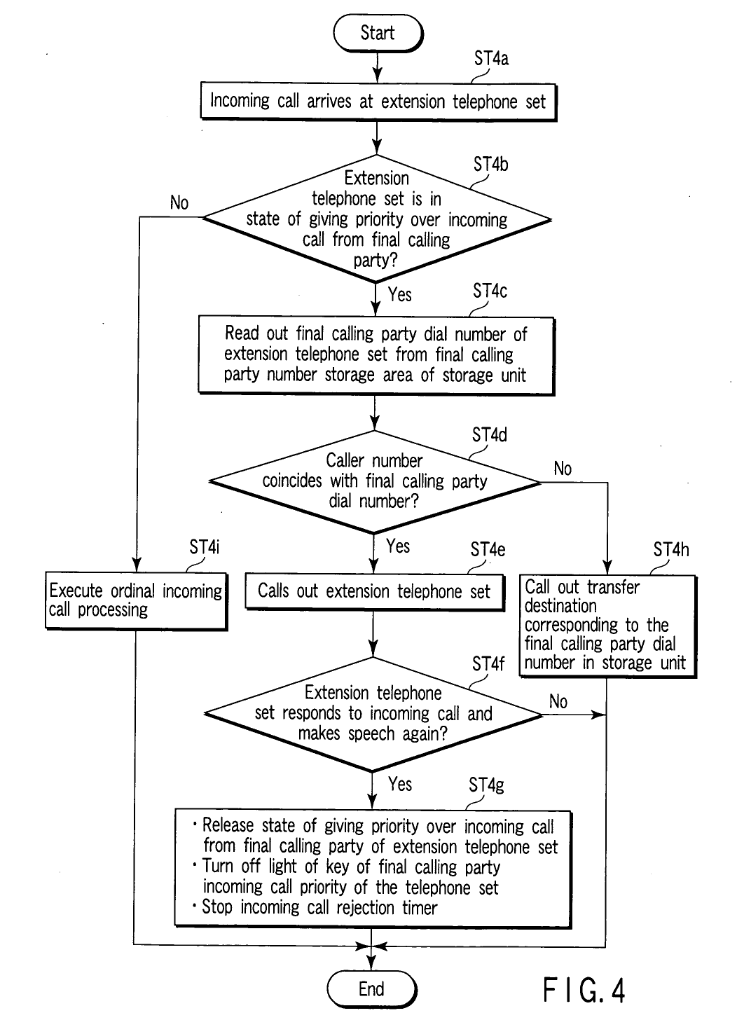

FIG. 4 is a flowchart illustrating a control processing procedure of the central control unit 14 when the incoming call arrives at the extension terminal DKT1.

It is presumed that the incoming call including the originating telephone number from the public network PNW arrives at the main apparatus 1 in response to the transmission from the external telephone terminal TT1.

The central control unit 14 of the main apparatus 1 then shifts from the block ST4a to the block ST4b, here determines whether or not the extension terminal DKT1 is in the state of giving the priority over the incoming call from the final calling party. Here, the extension terminal DKT1 being in the state of giving the priority over the incoming call from the final calling party, the central control unit 14 reads out the final calling party dial number corresponding to the extension terminal DKT1 from the table 151 (block ST4c) to determine whether or not the final calling party dial number coincides with the originating telephone number (block ST4d).

Here, they coinciding with each other, the central control unit 14 calls out the extension terminal DKT1 (block 4e), and if the user of the extension terminal DKT1 responds to this calling, it makes a shift from a block ST4f to a block ST4g, and here, it deletes the data corresponding to the extension terminal DKT1 in the table 151, turns off the light of the key 21 and stops the timer 18.

Meanwhile, when the incoming call destined to the extension terminal DKT1 from the extension terminal DKT3 arrives thereat, the central control unit 14 shifts from the block ST4d to a block ST4h, and here calls out the extension terminal DKTm at the incoming call transfer destination corresponding to the extension terminal DKT1 in the table 151.

In the block ST4b, if the extension terminal DKT1 is not in the state of giving the priority over the incoming call from the final calling party, the central control unit 14 executes ordinal incoming call processing to the extension terminal DKT1 (block ST4i).

As described above, in the first embodiment of the present invention, in a state in which a call connection has established between the external telephone terminal TT1 and the extension terminal DKT1, when the key 21 of the extension terminal DKT1 is depressed, the central control unit 14 creates data in which the extension telephone number of the extension terminal DKT1, the telephone number of the external telephone terminal TT1 and the telephone number of the extension terminal DKTm to be the incoming call transfer destination are related with one another to store it in the table 151. When the incoming call destined to the extension terminal DKT1 reaches again, the central control unit 14 determines whether or not the outgoing call origin has been registered in the table 151 by referring to the table 151 based on the telephone number of the outgoing call origin included in the incoming call, and if the outgoing call origin is the external telephone terminal TT1 which has been registered in the table 151, it makes the extension terminal DKT1 preferentially receive the incoming call.

Accordingly, with such a simple operation to depress the key 21 of the extension terminal DKT1 during the telephone call or after the completion thereof, the extension terminal DKT1 becomes possible to preferentially receive and respond for the incoming call which reaches by return after completing the speech from the external telephone terminal TT1, thereby, the simple operation drastically improves the convenience of the user.

In the first embodiment given above, after completing the telephone call between the extension terminal DKT1 and the external telephone terminal TT1, in a case where the incoming call destined to the extension terminal DKT1 from the extension terminal DKT3 has reached, if the arrival is made within the measurement time of the timer 18, it becomes possible to automatically transfer the incoming call and receive it to and by the extension terminal DKTm to be the incoming call transfer destination.

### SECOND EMBODIMENT

FIG. 5 is a flowchart illustrating a control processing procedure of the central control unit 14 when releasing the state of giving the priority over the incoming call form the final calling party of the extension terminal DKT1 by depressing the key 21 as a second embodiment of the present invention.

It is supposed that the extension terminal DKT1 is in the state of giving the priority over the incoming call form the final calling party. It is presumed that the user of the extension terminal DKT1 depresses the key 21 in such state. The central control unit 14 then shifts from the block ST5a to the block ST5b, and here, deletes the data relating to the extension terminal DKT1 in the table 151, turns off the light of the key 21, and stops the timer 18.

As mentioned above, the second embodiment can determine to instruct whether or not the user itself of the extension terminal DKT1 release the state of giving the priority over the incoming call form the final calling party. Thereby, the second embodiment becomes possible to preferentially receive the incoming call from the external telephone terminal TT1 only when it is absolutely required.

### THIRD EMBODIMENT

FIG. 6 is a flowchart illustrating a control processing procedure of the central control unit 14 in the case of time out by the timer 18.

It is assumed that the extension terminal DKT1 is in the state of giving the priority over the incoming call form the final calling. In that state, it is supposed that the incoming call reject time being set to the timer 18 has elapsed. The central control unit 14 then shifts from a block ST6a to a block ST6b, and here, deletes the data relating to the extension terminal DKT1 in the table 151 to turning off the light of the key 21.

As described above, the third embodiment can automatically update the table 151 without having to conduct update processing manually.

### OTHER EMBODIMENT

The present invention is not limited to each embodiment given above. For instance, in the first embodiment of the present invention, having described the example to depress the key 21 during the telephone call or after the completion thereof and subsequently input the setting to the incoming call reject timer and dial the transfer destination, it is also acceptable to implement only by depressing the key 21 by setting the timer and the dial in advance in construction order setting.

In the foregoing first embodiment, the function of the present invention having completed when the extension terminal and the final calling party becomes the telephone call state again, continuing the present invention until it will be cancelled by an intention of a user is a possible approach.

Other than this, the present invention may be embodied in various forms without departing from the spirit or scope of the general inventive concept thereof, as for the type (not limited to master unit and PBX is available) and configuration of the telephone exchange apparatus, type of the extension terminal, registration procedure of the final calling party management table, incoming call control procedure by return, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus executing exchange processing among a plurality of telephone terminals, comprising:
a memory which stores a management table in which a terminal ID specifying a first telephone terminal and a terminal ID specifying a second telephone terminal are related with each other, when an operation key to receive an incoming call from the second telephone terminal by the first telephone terminal on the highest priority in a state in which a call connection has established between the first telephone terminal and the second telephone terminal among the plurality of telephone terminals; and
a controller which refers to the management table based on a terminal ID of an outgoing call origin included in the incoming call when an incoming call destined to the first telephone terminal reaches, and executes incoming call control to the first telephone terminal only when the reference result shows that an outgoing call origin is the second telephone terminal.

2. The telephone exchange apparatus according to claim 1, further comprising a timer which measures a time to reject an incoming call from a third telephone terminal different from the second telephone terminal from a time point when the operation key is depressed by the first telephone terminal, wherein
the memory stores a management table in which a terminal ID of a fourth telephone terminal to be an incoming call transfer destination for the first telephone terminal is related in addition to the terminal IDs of the first and the second telephone terminals; and
the controller refers to the management table based on the terminal ID of the outgoing call origin included in the incoming call when the incoming call destined to the first telephone terminal reaches within a measurement time of the timer, and executes incoming call transfer control to the fourth telephone terminal when the reference result shows that the outgoing call origin is the third telephone terminal.

3. The telephone exchange apparatus according to claim 2, wherein the controller automatically deletes the management table after elapse of the measurement time of the timer.

4. The telephone exchange apparatus according to claim 1, further comprising: a notice unit which notifies the fact of creating the management table to a user of the first telephone terminal when the management table is created.

5. The telephone exchange apparatus according to claim 4, wherein the controller deletes the management table when the operation key of the first telephone terminal is depressed in response to a notification from the notice unit.

6. A method for controlling incoming calls of a telephone exchange apparatus which executes exchange processing among a plurality of telephone terminals, comprising:
creating a management table in which a terminal ID specifying a first telephone terminal and a terminal ID specifying a second telephone terminal are related with each other when an operation key to receive an incoming call from the second telephone terminal by the first telephone terminal on the highest priority in a state in which a call connection has established between the first and the second telephone terminals among the plurality of telephone terminals;
referring to the management table based on a terminal ID of an outgoing call origin included in the incoming call when an incoming call destined to the first telephone terminal reaches; and
executing incoming call control to the first telephone terminal only when the reference result shows that the outgoing call origin is the second telephone terminal.
